(19) United States
(12) Patent Application Publication
(10) Pub. No.: US 2017/0093184 A1
(43) Pub. Date: Mar. 30, 2017

(54) METHOD, SYSTEM AND DEVICE FOR POWER CELL MANAGEMENT

(71) Applicant: VOOLT, LLC, Phoenix, AZ (US)

(72) Inventors: Peter Austin JOHNSON, Phoenix, AZ (US); Rodney Kenji NAKAMOTO, Phoenix, AZ (US); Beau Henry RALPHS, Phoenix, AZ (US)

(21) Appl. No.: 15/275,933

(22) Filed: Sep. 26, 2016

Related U.S. Application Data
(60) Provisional application No. 62/233,103, filed on Sep. 25, 2015.

(51) Int. Cl. H02J 7/00

(52) U.S. Cl. CPC H02J 7/0016; H02J 7/0021

(57) ABSTRACT

A power management device for an electrically powered apparatus includes a plurality of cell management circuits and a controller. Each cell management circuit includes a set of terminals to receive one power cell; a boost converter connected to an output of the terminals; and an energy storage component selectively connected to one of an output of the boost converter, for receiving and storing energy from the boost converter, and an output of the cell management circuit, for delivering energy to the apparatus. The controller is configured, for each cell management circuit, to: obtain a cell output level; based on the cell output level, select a boost output level for the boost converter; and alternately connect the energy storage component to the boost converter output to collect energy from the boost converter at the boost output level, and the management circuit output to deliver the energy to the apparatus.

### CROSS-REFERENCE TO RELATED APPLICATION

This application claims priority from U.S. Provisional Patent Application No. 62/233,103, filed Sep. 25, 2015, the content of which is incorporated herein by reference.

### FIELD

The specification relates generally to electrically powered apparatuses, and specifically to a method, system and device for power cell management.

### BACKGROUND

The proliferation of portable electronic devices has driven a significant increase in demand for battery power over the past two decades. Many electronic devices require a minimum voltage to operate. For a device powered by AA cells, this minimum may be, for example, 1.1 or 1.2V per cell. As a result, multiple batteries may be discarded when a single one of a set of batteries falls below that minimum. A portion of the discarded batteries may in fact still contain usable energy. The increased consumption and discarding of batteries as a result of such potentially premature discarding incurs both financial and environmental costs.

### SUMMARY

According to an aspect of the specification, a power management device for an electrically powered apparatus is provided, comprising: a plurality of cell management circuits, each circuit comprising: a set of terminals to receive one power cell; a boost converter connected to an output of the terminals; and an energy storage component selectively connected to one of (i) an output of the boost converter, for receiving and storing energy from the boost converter, and (ii) an output of the cell management circuit, for delivering energy to the apparatus; and a controller in communication with each of the plurality of cell management circuits and configured, for each cell management circuit, to: obtain a cell output level; based on the cell output level, select a boost output level for the boost converter; and alternately connect the energy storage component to (i) the boost converter output to collect energy from the boost converter at the boost output level, and (ii) the cell management circuit output to deliver the energy to the apparatus.

According to another aspect of the specification, a method is provided of controlling a power management device having a plurality of cell management circuits each including a set of terminals to receive a power cell, a boost converter connected to an output of the terminals and an energy storage component, the method comprising: for each cell management circuit: obtaining a cell output level for the power cell; based on the cell output level, select a boost output level for the boost converter; and alternately connect the energy storage component to (i) the boost converter output to collect energy from the boost converter at the boost output level, and (ii) a cell management circuit output to deliver the energy to an electrically powered apparatus.

### BRIEF DESCRIPTIONS OF THE DRAWINGS

Embodiments are described with reference to the following figures, in which:

FIG. 1 depicts a power management device 100 for providing power to an apparatus, according to a non-limiting embodiment;

FIG. 2 depicts the power management device of FIG. 1 in greater detail, according to a non-limiting embodiment; and

FIG. 3 depicts a method of power cell management implemented by the device of FIG. 2, according to a non-limiting embodiment.

### DETAILED DESCRIPTION OF THE EMBODIMENTS

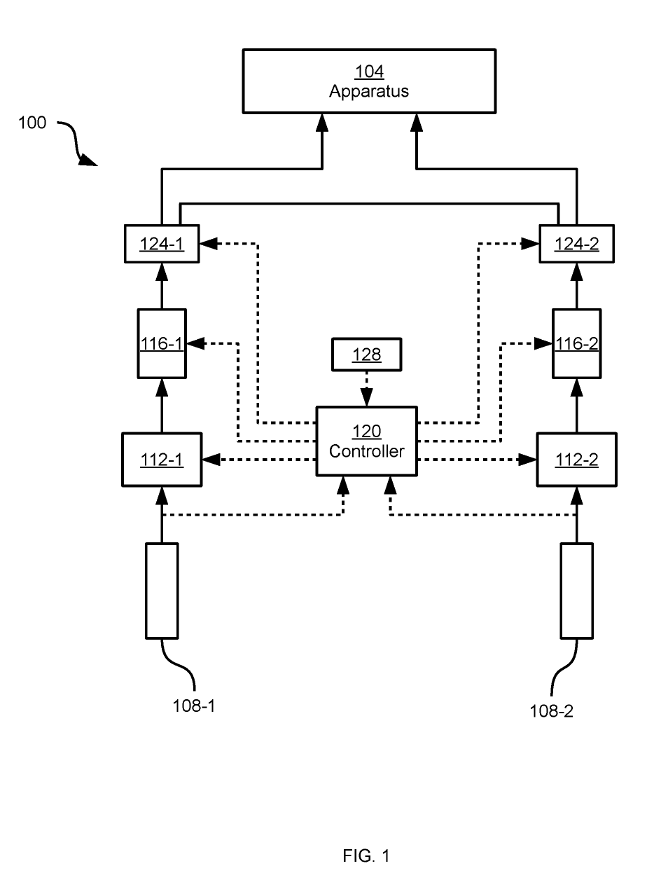

FIG. 1 depicts a power management device 100 for an electrically powered apparatus 104. Apparatus 104, more specifically, is configured to receive electrical power from a plurality of power cells 108-1, 108-2 (collectively referred to as power cells 108, and generically referred to as a power cell 108; similar nomenclature is used herein for other elements). Two power cells 108 are shown in FIG. 1, although in other embodiments apparatus 104 may be configured to receive power from a greater number of power cells 108 (e.g. three, four, eight and so on). Power management device 100 can be implemented in connection with a wide variety of types of apparatus 104 and power cells 108. For example, apparatus 104 can be a toy, a remote control, a portable entertainment device, a wireless sensor node, or the like. Power cells 108 are any suitable electrochemical batteries (e.g. AA, AAA, C, D batteries and the like, having any suitable electrochemical composition, such as alkaline or lithium-based).

As will now be apparent, conventional apparatuses such as the above-mentioned battery-powered toys include battery terminals that are configured to receive batteries and connect the batteries in series or in parallel. The output of the connected batteries is provided directly to the electrically powered components of the apparatus (e.g. the motor in a remote-controlled toy vehicle). In the embodiments discussed herein, on the other hand, power management device 100 is connected between power cells 108 and apparatus 104, and performs various actions to manipulate the energy output of power cells 108 and deliver the manipulated output to apparatus 104.

Device 100 includes a plurality of cell management circuits; two cell management circuits are shown in FIG. 1, although it is contemplated that in embodiments in which a greater number of power cells 108 are employed to power apparatus 104, a correspondingly greater number of cell management circuits are provided. In other words, a cell management circuit is provided for each power cell required to power apparatus 104.

Each cell management circuit includes a set of terminals to receive a power cell 108. The terminals are not illustrated in FIG. 1 for simplicity (as will be apparent to those skilled in the art, various circuit elements, such as connections to ground, are also omitted in FIG. 1 for simplicity of illustration). The terminals may be, for example, resilient conductive contacts arranged to align with the positive and negative terminals of the corresponding power cell.

Each cell management circuit also includes a boost converter 112-1, 112-2 connected to an output of the terminals to receive electrical energy from the output. Any suitable conventional boost converter may be employed. In general, boost converters 112 accept electrical energy at a given voltage and current, and output electrical energy at an output voltage equal to or greater to the input voltage, and an output current equal to or smaller than the input current. Boost converters 112 are preferably digitally controllable, such that the output levels of boost converters 112 can be controlled independently.

Each cell management circuit also includes an energy storage component 116-1, 116-2. The energy storage component 116 of each cell management circuit is configured to be selectively switched between two output connections. The first connection is to the output of the corresponding boost converter 112, for the storage component 116 to receive and store energy from the boost converter 112. The second connection is to an output of the cell management circuit as a whole, for the storage component 116 to deliver the energy stored therein to apparatus 104. In other words, the energy storage components 116 are each switchable between a charging mode (receiving and storing energy from a corresponding boost converter 112) and a discharging mode (delivering the previously stored energy to apparatus 104).

In the present embodiment, each energy storage component 116 is implemented as a capacitor. For example, each energy storage component 116 can be a supercapacitor (e.g. an electric double-layer capacitor).

Device 100 also includes a central controller 120 in communication with all of the cell management circuits. Controller 120 includes one or more integrated circuits (ICs), including a memory configured to store computer-readable instructions and data, a processor configured to execute the computer-readable instructions to generate output data, and a communications interface for connecting controller 120 to other components of device 100. In the present embodiment, controller 120 is implemented as an ultra-low power microcontroller configured to store and execute a firmware application to collect data from and issue control signals to certain components of device 100. As seen in FIG. 1, communication connections between controller 120 and other components of device 100 are shown in dashed lines (in contrast to the solid lines used to indicate power transmission). Controller 120 also receives electrical power, for example from the cell management circuit outputs, although such a power connection is not illustrated in FIG. 1 for simplicity.

Controller 120 is configured, for each cell management circuit, to monitor the state of the power cell 108 connected to that cell management circuit (e.g. via the dashed lines shown between controller 120 and the power lines connecting power cells 108 and boost converters 112 in FIG. 1), and to control the operation of boost converters 112 and energy storage components 116 based on the monitored state of the power cells 108. In general, controller 120 is configured to effect the above-mentioned control to compensate for partial or complete depletion of one or more power cells 108, to provide apparatus 104 with sufficient power to continue operating. The actions taken by controller 120 will be discussed below in greater detail.

In the present embodiment, each cell management circuit also includes at least one switching component 124-1, 124-2. Switches 124 are configured to receive energy from respective energy storage components 116, for delivery to apparatus 104. Switches 124 are also connected via communication lines with controller 120, which is configured to set each switch 124 in one of a plurality of predefined configurations. In the present embodiment, switches 124 have at least a first position and a second position. In the first position, switches 124 are configured to connect the output of the cell management circuits in parallel, and in the second position switches 124 are configured to connect the output of the cell management circuits in series. As seen in FIG. 1, when both switches 124 are configured to direct the power output from their corresponding cell management circuits directly to apparatus 104, the cell management circuits are effectively connected to apparatus 104 in parallel. On the other hand, when, for example, switch 124-1 directs the output of its corresponding cell management circuit to switch 124-2 prior to direction of the output of both cell management circuits to apparatus 104, the cell management circuits are effectively connected to apparatus 104 in series.

In the present embodiment, controller 120 is configured to set the configuration of switches 124 responsive to obtaining configuration data from a configuration storage device 128 connected to controller 120. Configuration storage device 128 stores data indicating the number of cells 108 employed to power apparatus 104, the type of cells 108 (e.g. the voltage of cells 108, or an indication of a standard size such as AA which itself indicates the voltage of cells 108), and whether the cells 108 are in a parallel or series configuration. Responsive to obtaining the configuration data, controller 120 is configured to set switches 124 to the appropriate positions.

The configuration storage device 128 is, in the present example, a set of configuration pins. For example, pairs of jumper pins connected to controller 120 are provided, each pair corresponding to a given setting (e.g. a pair for parallel or series cell configuration, one or more pairs for distinguishing between pairs of battery types or voltages, and the like). The placement or omission of a jumper on each pair of pins enables controller 120 to derive the above-mentioned configuration data by detecting which pairs of jumper pins are shorted and which pairs of jumper pins are open. Thus, configuration data can be encoded in the jumper pins, for example during the manufacture of apparatus 104, once device 100 has been inserted in or otherwise connected to apparatus 104. In other embodiments, configuration data can instead be stored in memory at controller 120 (e.g. loaded onto controller 120 from another computing device during the manufacture of apparatus 104 or controller 120).

In other embodiments, switches 124 can be omitted, and device 100 can instead be constructed with the cell management circuits in a fixed parallel or series configuration (or a combination thereof). As will be discussed below in greater detail, when switches 124 or additional switch components not shown in FIG. 1 are included, such switches can also be configured by controller 120 to enable and disable cell management circuits, and to alternate energy storage elements 116 between the above-mentioned charging and discharging modes. Each of switches 124-1 and 124-2 is implemented as any suitable analog switch, or collection of analog switches. For example, each switch 124 can be implemented as an integrated circuit containing a set of independently controllable switches.

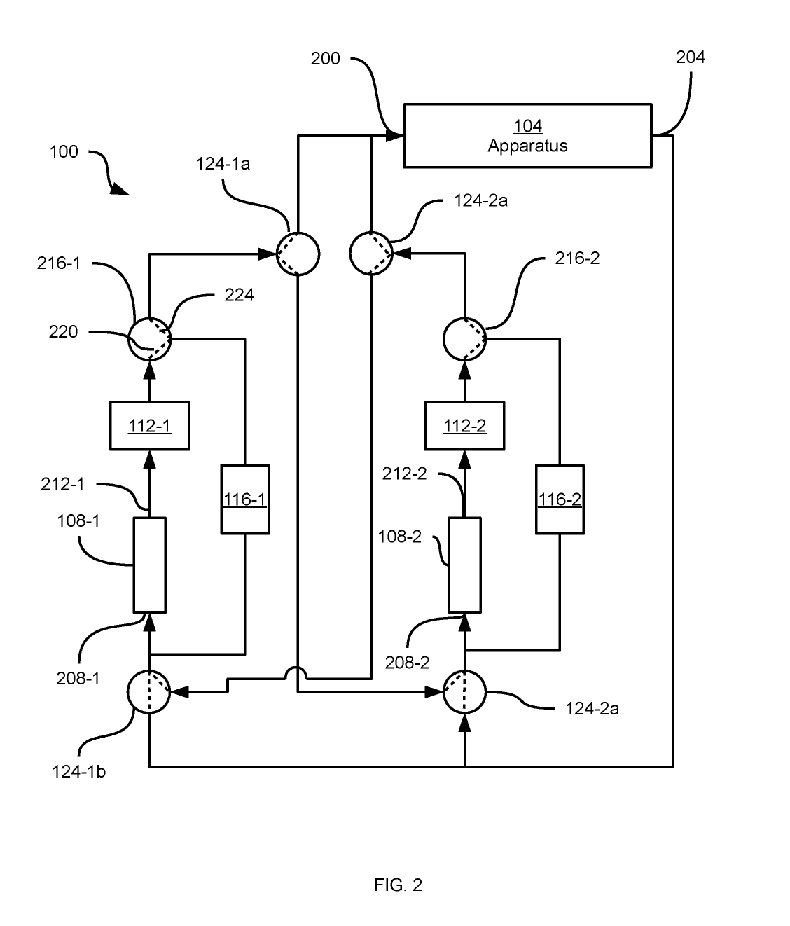

Turning now to FIG. 2, device 100 according to certain embodiments is shown in greater detail. Controller 120 is omitted in FIG. 2 to allow for clearer illustration of the power-carrying connections between the components of device 100. In particular, apparatus 104 as shown includes a power input terminal 200, at which apparatus 104 receives power from device 100, and a neutral or ground terminal 204 which is also connected to neutral or ground cell terminals 208-1 and 208-2 (with an exception to be discussed below).

The positive (or output) terminals 212-1 and 212-2 of each cell management circuit are connected to the input of the respective boost converter 112. The output of each boost converter 112 is connected to a switch 216-1, 216-2, which may be implemented as MOSFET-based switches, an additional set of analog switches, or in some embodiments, additional switches included in the IC package of switches 124. Switches 216 serve to alternate energy storage components 116 (supercapacitors, in the present embodiment) between the charging and discharging modes mentioned above. In particular, with reference to switch 216-1, in a charging position 220, switch 216-1 directs energy from the output of boost converter 112-1 into storage component 116-1. When switch 216-1 is in position 220, the corresponding cell management circuit does not delivery power to apparatus 104.

When switch 216-1 is in position 224, however, energy storage component 116-1 is connected, through switch 124-1, to terminal 200 to deliver the stored energy to apparatus 204. In such a configuration, it will now be apparent that power cell 108-1 and boost converter 112-1 do not deliver power to either energy storage component 116-1 or apparatus 104. As will be seen below in greater detail, controller 120 is configured to control the operation of switches 216 to alternate storage components 116 between charging and discharging modes.

Also shown in greater detail in FIG. 2 are switches 124-1 and 124-2. Switch 124-1 is shown as having two components 124-1a and 124-1b, and switch 124-2 is shown as having two components 124-2a and 124-2b. The components of each switch 124 are illustrated separately in FIG. 2, but need not be physically separate. Instead, the components may simply be distinct switches integrated in the same analog switch package. The discussion below relates to switch 124-1, but the features of switch 124-2 will also be apparent therefrom.

Switch 124-1 has two positions. In the first position, as mentioned earlier, switch 124-1 is configured to connect the corresponding cell management circuit in parallel with the other cell management circuit (or circuits, where device 100 includes more than two cell management circuits). In particular, in the first position, switch component 124-1a is configured to connect the output of its cell management circuit to terminal 200, and switch component 124-1b is configured to connect neutral terminal 208 to terminal 204 of apparatus 104 (i.e. to ground).

In the second position, by contrast, switch component 124a-1 is configured to connect the output of the corresponding cell management circuit not directly to terminal 200, but to switch 124-2 (specifically, to switch component 124-2b), which in turn is configured to connect the output from switch component 124-1a to terminal 208-2. Thus, the first cell management circuit is connected in series with the second cell management circuit. In such a configuration, switch component 124-2a connects the output of the second cell management circuit directly to terminal 200, and switch component 124-1b connects terminal 208-1 to terminal 204.

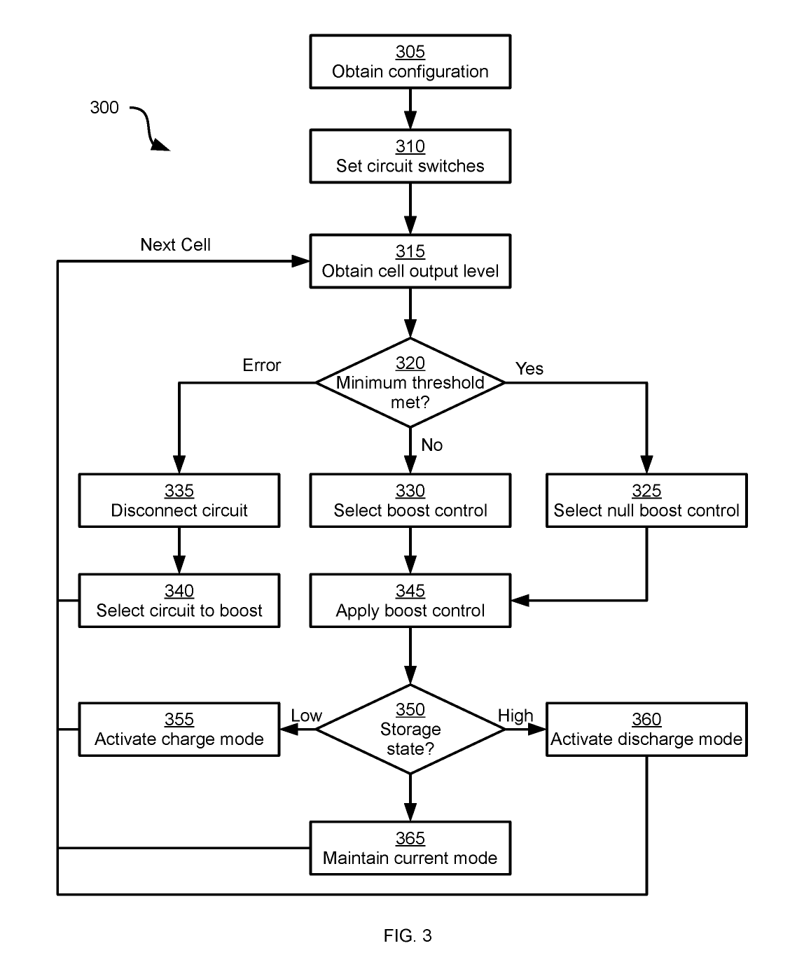

Turning now to FIG. 3, the control of device 100 by controller 120 will be described in greater detail. In particular, FIG. 3 illustrates a method 300 of power cell management. Method 300 will be discussed in connection with its performance on device 100 as illustrated in FIGS. 1 and 2, although it will be apparent that method 300 can also be performed on variations of device 100. The blocks of method 300 are performed by controller 120, via the execution of the above-mentioned computer-readable instructions (also referred to herein as firmware).

At block 305, controller 120 is configured to obtain configuration data. In the present example, at block 305 controller 120 determines which of the above-mentioned pairs of jumper pins are shorted and which pairs are open. Controller 120 can store a lookup table with a record corresponding to each pair of pins, the record containing configuration parameters corresponding to each of the open and shorted states. Thus, by reading the state of the configuration pins, controller 120 is configured to derive configuration data indicating the number of cell management circuits present (i.e. the expected number of power cells 108), the output level of each cell 108, and the expected circuit configuration of the cells 108 (i.e. whether the cells 108 are to be connected in series or in parallel).

Other formats are also contemplated for the configuration data. For example, separate types and output levels can be specified for each individual power cell, allowing disparate power cells (e.g. having different nominal voltages) to be employed in conjunction with device 100. As a further example, a total output voltage may be specified rather than a circuit configuration. With the cell voltages and the total output voltage to apparatus 104, controller 120 can derive whether the cells are to be arranged in series or in parallel. As noted earlier, in other embodiments configuration data can be loaded directly from a memory of controller 120 rather than being derived from configuration pin readings.

At block 310, having obtained the configuration data, controller 120 is configured to set switches 124 to arrange the cell management circuits in parallel or in series, according to the configuration. At block 315, controller 120 is configured to obtain an output level for the power cell 108 of a first one of the cell management circuits. Thus, in the present example, controller 120 is configured to obtain a voltage level at terminal 212-1.

At block 320, controller 120 is configured to determine whether the voltage level obtained at block 315 meets a minimum threshold. As set forth below, based on the determination at block 320, controller 120 is configured to select an output level for the boost converter 112.

The minimum threshold is a voltage below which the relevant power cell 108 may impede operation of the apparatus 104. The minimum threshold can be obtained by controller 120 by applying a predefined factor (e.g. 0.8) to the total voltage to be supplied to apparatus 108 as determined from the configuration data. For example, for two AA power cells 108 to be connected in series, the total voltage supplied to apparatus 104 (assuming both cells are fresh) is 3V (each cell supplying 1.5V). Thus, controller 120 can determine a minimum threshold of 1.2V for each cell.

When the minimum threshold is met (that is, the output level obtained at block 315 is above the minimum threshold, controller 120 is configured to select a null boost control parameter, at block 325. The null boost control parameter configures the corresponding boost converter 112 to simply pass through the voltage received from the power cell 108. When the minimum threshold is not met, on the other hand, controller 120 is configured to select a boost control parameter corresponding to the nominal output of the power cell 108 (e.g. 1.5V in the case of a AA cell), at block 330.

Further, controller 120 is configured to proceed to block 335 when the cell output level obtained at block 315 indicates an error. An error state is indicated, for example, by an output level below a depletion threshold stored in the memory of controller 120 for the relevant type of power cell (e.g. 0.6V for a AA cell; the depletion threshold may be set lower, although certain battery chemistries may become unstable at lower voltages), or when no output is detected at block 315 (e.g. indicating a failed or defective cell). At block 335, controller 120 is configured to simply disable the corresponding cell management circuit. Disconnection of a cell management circuit can be accomplished, referring briefly to FIG. 2, by setting switch 216-1 to a position intermediate to positions 220 and 224, such that both storage component 116-1 and the output of boost converter 112-1 are disconnected from switch component 124-1a.

Returning to FIG. 3, at block 340 controller 120 is configured to select a different cell management circuit than the circuit currently being processed, and to store an indication in memory (e.g. by setting a flag in association with that cell management circuit) to apply additional boosting to that circuit. The selection of another circuit to apply additional boosting to can be made in a variety of ways. For example, controller 120 can select the cell management circuit currently having the highest cell output level (as obtained at block 315). In other embodiments, controller 120 is configured to apply additional boosting to the next cell management circuit to be processed according to method 300. In further embodiments, controller 120 is configured to apply a portion of nominal cell voltage to each of a plurality of other cell management circuits. That is, if a 1.5V cell is determined to have failed, additional boost voltage of 0.5V may be applied to three distinct cell management circuits, rather than 1.5V being applied to a single cell management circuit.

Controller 120 can also be configured to set an indication in the memory to the effect that the current cell management circuit has been disabled (and is therefore not to be selected for additional boosting itself in the event of an error on a different cell management circuit). Having performed block 340, controller 120 returns to block 315 to obtain an output level for the next cell management circuit.

When blocks 325 or 330 have been performed for a given cell management circuit rather than block 335, controller 120 is configured to proceed to block 345. At block 345, controller 120 is configured to apply the boost control parameter selected at block 325 or 330 to the corresponding boost converter 112. In other words, controller 120 is configured to send an instruction to the relevant boost converter 112 including the selected boost control parameter. Controller 120 is also configured, at block 345, to determine whether the current cell management circuit has been indicated in memory as requiring additional boosting to accommodate another failed cell management circuit. Such indications are additive to the control parameters selected at blocks 325 and 330. For example, if a cell with a nominal voltage of 1.5V reads an output of 1.5V at block 315, controller 120 is configured to select a null boost control parameter at block 325 (i.e. a boost control parameter of 1.5V, effectively configuring the boost converter 112 as a pass-through element). However, if the cell management circuit was previously selected for additional boosting because a separate power cell 108 failed, at block 345 controller 120 can be configured to apply a boost control parameter of 3V, representing the null boost control parameter plus an additional boost level to replace the “lost” output from the failed cell.

Having applied the boost control parameter, at block 350 controller 120 is configured to determine the energy storage state of the energy storage component 116 corresponding to the cell 108 assessed at block 315 and the boost converter 112 controller at block 345. The state of the storage component 116 can be assessed, for example, by obtaining a voltage reading across the terminals of the storage component 116. When the storage state is below a lower threshold (e.g. the depletion threshold mentioned earlier), at block 355 controller 120 is configured to set the storage component 116 to the charging mode. In the present example, storage component 116-1 is placed in the charging mode by setting switch 216-1 to position 220.

When the storage state is above an upper threshold (e.g. equal to the boost control parameter applied at block 345), at block 360 controller 120 is configured to set the storage component 116 to the discharging mode. In the present example, storage component 116-1 is placed in the discharging mode by setting switch 216-1 to position 224

As will now be apparent, power cells 108 nearing depletion may not be able to drive the storage device to the boost control parameter from block 345. Thus, controller 120 can also be configured to set the upper threshold to a fraction (e.g. 80%) of the boost control parameter. In other embodiments, controller 120 can be configured to proceed to block 360 not in response to the storage component 116 reaching a certain voltage, but in response to the voltage obtained remaining substantially stationary for a threshold time period (e.g. 10 ms).

When the storage state neither falls below the lower threshold nor rises above the upper threshold, controller 120 is configured to maintain the storage component 116 in the current mode, at block 365. As will now be apparent, therefore, as energy storage component 116 collects energy from the corresponding boost converter 112 and delivers the stored energy to apparatus 104, controller 120 is configured to alternately connect the storage component 116 to the boost converter 112 and the apparatus 104.

Following the performance of block 365, controller 120 returns to block 315, and repeats the performance of the remainder of method 300 for the next cell management circuit. It is also contemplated that method 300 need not be performed in a single sequence as described herein and shown in FIG. 3. For example, the storage components 116 can be managed separately from the control of boost converters 112. That is, blocks 350-365 can be performed separately and in parallel with blocks 315-345. Further, a plurality of instances of the above portions of method 300 can be performed for distinct cell management circuits, rather than one cell management circuit at a time. More generally, the blocks of method 300 can be implemented on controller 120 in an event-based computing environment, in which controller 120 monitors input data for changes in power cell voltage, capacitor charge states, and the like, and responds to each event independently.

Variations to the above device and method are contemplated, in addition to those already discussed. For example, although in method 300 the circuit configuration switches 124 are set once at block 310, in other embodiments controller 120 may alter the state of switches 124 dynamically during the operation of device 100. Such dynamic alteration may be employed, for example, in connection with an apparatus 104 including a wireless transceiver, whose current demands may rise substantially during transmissions. In such embodiments, controller 120 is configured to detect a rise in current demand (e.g. by detecting when the time taken to discharge energy storage components 116 falls below a threshold), and responsive to such a detection, to connect the cell management circuits in parallel rather than in series. To prevent the total voltage provided to apparatus 104 from decreasing, controller 120 is also configured to apply additional boosting (e.g. via the indication stored in memory as mentioned earlier) to each circuit. When the increased current demand is no longer detected, controller 120 is configured to revert to the original configuration specified by the configuration data obtained at block 305.

In further variations, device 100 includes one or more output components such as a display, LED indicator, speaker or the like. For example, device 100 can include one LED indicator for each cell management circuit. Controller 120 can be configured to illuminate each LED indicator corresponding to a cell management circuit containing a failed power cell 108, indicating that the power cell requires replacement.

Device 100 may be implemented in a variety of structures. For example, the components of device 100 can be mounted on a substrate such as a printed circuit board (PCB). More specifically, in certain embodiments the terminals for receiving power cells are mounted on a first side of the PCB, which is exposed when a battery cover is removed from apparatus 104. The remaining components of device 100 are on an opposite second side of the PCB, thus permitting ready connection to the internal power handling hardware of apparatus 104 as well as protection from the external environment of apparatus 104.

Various advantages of device 100 will now be apparent. For example, device 100, through dynamic control of boost converters 112 corresponding to individual power cells 108, may permit each power cell 108 to be discharged to depletion. The use of energy storage components 116 with distinct charging and discharging modes may permit power cells 108 to continue to deliver energy when they would be unable to do so if exposed directly to the load imposed by apparatus 104 (even with boost converters 112 in place). Device 100 may therefore reduce the frequency with which batteries must be replaced in apparatus 104. As a further example, the implementation of controller 120 discussed herein may allow controller 120 and associated firmware to be implemented to control power management devices with various different numbers of cell management circuits, with little or no modification required to controller 120 (and its firmware) itself. Other advantages may also occur to those skilled in the art.

Those skilled in the art will appreciate that in some embodiments, the functionality of controller 120 and the associated firmware may be implemented using pre-programmed hardware or firmware elements (e.g., application specific integrated circuits (ASICs), electrically erasable programmable read-only memories (EEPROMs), etc.), or other related components.

The scope of the claims should not be limited by the embodiments set forth in the above examples, but should be given the broadest interpretation consistent with the description as a whole.

1. A power management device for an electrically powered apparatus, comprising:
a plurality of cell management circuits, each circuit comprising:
a set of terminals to receive one power cell;
a boost converter connected to an output of the terminals; and
an energy storage component selectively connected to one of (i) an output of the boost converter, for receiving and storing energy from the boost converter, and (ii) an output of the cell management circuit, for delivering energy to the apparatus; and
a controller in communication with each of the plurality of cell management circuits and configured, for each cell management circuit, to:
obtain a cell output level;
based on the cell output level, select a boost output level for the boost converter; and
alternately connect the energy storage component to (i) the boost converter output to collect energy from the boost converter at the boost output level, and (ii) the cell management circuit output to deliver the energy to the apparatus.

2. The power management device of claim 1, the controller further configured to:
obtain configuration data defining a nominal output level for each power cell; and
select the boost output level based on a comparison between the cell output level and the nominal output level.

3. The power management device of claim 2, the controller further configured to select the boost output level equal to the nominal output level when the cell output level is below a predefined fraction of the nominal output level.

4. The power management device of claim 1, the controller further configured to:
detect, based on the cell output level, a power cell failure in a first one of the cell management circuits;
responsive to the detection, select a second one of the cell management circuits; and
select a boost output level for the second one of the cell management circuits.

5. The power management device of claim 2, further comprising:
a plurality of configuration pins;
the controller further configured to retrieve the configuration data from a memory based on a detection of a subset of the configuration pins that are shorted.

6. The power management device of claim 2, further comprising:
at least one switch configured to connect the plurality of cell management circuits in one of a parallel configuration and a series configuration.

7. The power management device of claim 6, wherein the at least one switch includes an analog switch corresponding to each of the cell management circuits.

8. The power management device of claim 6, the controller further configured to control the at least one switch to connect the plurality of cell management circuits in one of the parallel and series configurations based on the configuration data.

9. The power management device of claim 1, further comprising:
a substrate supporting the plurality of cell management circuits and the controller.

10. The power management device of claim 9, wherein the set of terminals of each cell management circuit are supported on a first side of the substrate, and wherein controller, the boost converter and the energy storage component of each cell management circuit are supported on an opposite side of the substrate.

11. A method of controlling a power management device having a plurality of cell management circuits each including a set of terminals to receive a power cell, a boost converter connected to an output of the terminals and an energy storage component, the method comprising:
for each cell management circuit:
obtaining a cell output level for the power cell;
based on the cell output level, select a boost output level for the boost converter; and
alternately connect the energy storage component to (i) the boost converter output to collect energy from the boost converter at the boost output level, and (ii) a cell management circuit output to deliver the energy to an electrically powered apparatus.

12. The method of claim 11, further comprising:
obtaining configuration data defining a nominal output level for each power cell; and
selecting each boost output level based on a comparison between the cell output level and the nominal output level.

13. The method of claim 12, wherein selecting the boost output level comprises selecting the boost output level equal to the nominal output level when the cell output level is below a predefined fraction of the nominal output level.

14. The method of claim 11, further comprising:
detecting, based on the cell output level, a power cell failure in a first one of the cell management circuits;
responsive to the detection, selecting a second one of the cell management circuits; and
selecting a boost output level for the second one of the cell management circuits.

15. The method of claim 12, wherein the power management device includes a plurality of configuration pins; and
wherein obtaining the configuration data comprises retrieving the configuration data from a memory based on a detection of a subset of the configuration pins that are shorted.

16. The method of claim 12, wherein the power management device includes at least one switch configured to connect the plurality of cell management circuits in one of a parallel configuration and a series configuration; the method further comprising:
controlling the at least one switch to connect the plurality of cell management circuits in one of the parallel and series configurations based on the configuration data.
